(19) United States
(12) Patent Application Publication
(10) Pub. No.: US 2005/0177525 A1
(43) Pub. Date: Aug. 11, 2005

(54) Sales and service offer method and apparatus

(76) Inventors: John Ray Apple, San Francisco, CA (US); Bruce Withers, Livermore, CA (US); Czarina V. Good, Albany, CA (US); Randy Ly, San Francisco, CA (US)

Correspondence Address: GLENN PATENT GROUP, 3475 EDISON WAY, SUITE L, MENLO PARK, CA, 94025, US

(21) Appl. No.: 10/774,019

(22) Filed: Feb. 6, 2004

(51) Int. Cl. G06G 7/00

(52) U.S. Cl. 705/400

(57) ABSTRACT

A mechanism is provided that identifies a customer and attaches to a customer inquiry a relevant sales or service offer code. When a sales/service agent is in contact with the customer, the sales/service agent's display illuminates a sales/service offer icon as appropriate. When the sales/service agent clicks on the icon, the system calls an associated URL and launches a browser, which then displays a description of the offer and a suggestion script. After presenting the offer to the customer, the sales/service agent selects an appropriate disposition code, which is recorded in a database with regard to offer status. One key aspect of the invention concerns passing a URL associated with an offer along with a phone call to an agent in a call center.

### BACKGROUND OF THE INVENTION

1. Technical Field

The invention relates to customer relations management systems. More particularly, the invention relates to a sales and service offer method and apparatus.

2. Description of the Prior Art

One issue affecting customer service organizations is that of providing a low cost and flexible system for presenting targeted sales offers and/or customer service to customers, where call center agents are alerted to such offers via a call center desktop application during a service related customer call.

The Wells Fargo (San Francisco, Calif.) telephone banking group has piloted a sales offer system known as “Quicker Offer.” Although Quicker Offer presented high-quality targeted sales offers to customers, the system required a full desktop software release each time an offer was added or modified. The desktop software release process is time consuming, taking over two months, and requires expensive engineering, testing, and roll out.

Other software developers for call center businesses have used computer telephony integration (CTI) applications to attach and pass descriptive text for sales offers or notifications of service impacts, e.g. misposted interest or statement problems.

There are several disadvantages in using this method:

First, the attached data, i.e. the offer information, is hard coded within the CTI call routing strategy, making it necessary to update each strategy every time the attached data are changed. For example, if in January a financial institution was running a credit card promotion, but needed to change that in favor of a savings account offer in February, it would be necessary to update the attached offer data in every routing strategy. Large call centers typically have a hundred or more routing strategies in use at any given time.

A second implication of having to update each routing strategy is that the speed to market and risk of error are significantly greater when each strategy must be modified. Additionally, when modifying routing strategies, calls in process are impacted such that the attached data may be dropped.

A third limitation with this approach is the presentation format of the attached data is static on the call center desktop. The desktop must read and parse the data and present them in a predetermined place on the active desktop.

An alternate approach that might solve the first two challenges above is to put the various scripts in a database and modify the stored procedure to facilitate changing the script. However, this approach does nothing to solve the third limitation, i.e. the inability of the desktop to display the scripts and any new disposition codes required to support modified scripting flexibly.

It would be advantageous to provide a low cost and flexible system for presenting targeted sales offers and/or customer service to customers, where call center agents are alerted to such offers via a call center desktop application during a service related customer call.

### SUMMARY OF THE INVENTION

The invention provides a low cost and flexible system for presenting targeted sales offers and/or customer service to customers, where call center agents are alerted to such offers via a call center desktop application during a service related customer call. The preferred embodiment of the invention leverages existing interactive voice response (IVR), CTI, and customer information view (CIV), i.e. agent desktop, infrastructure, and extends current CTI capabilities.

In a preferred embodiment, the IVR is used to attach pieces of data to an agent initiated database query, where such pieces of data are gathered either directly by customer entered digits (CED's) or following a database lookup based upon CED's. The data are organized in a one-to-one relationship, known as key value pairs. For example, for the data element account number, the key is AcctNum and the value is 0836553285. The key value pairs are passed to the CIV desktop application in a string via CTI software, such as that provided by Genesys Laboratories (Daly City, Calif.) or Cisco Systems (San Jose, Calif.).

The CTI software calls a stored procedure from within the routing strategy using the account number and SSN that were attached as key value pairs by the IVR. The stored procedure performs a database lookup using the account number and social security number (SSN) as input arguments. When matching on an SSN, a sales offer code and sales offer URL are attached as key value pairs. As a result of a match on account number, a service offer code and service offer URL are attached as key value pairs. In either case, the additional key value pairs are appended to the string and passed to the desktop.

The desktop interrogates the string of key value pairs. When an offer code and URL are present, the desktop illuminates a sales offer icon and/or a service offer icon on the call center agent's desktop as appropriate. Once the call center agent clicks on an icon, the desktop calls the URL passed in the string and launches a browser. An ASP file is pushed to the desktop and an HTML page within the browser displays a description of the offer and a suggested script for the sales agent to follow when presenting the offer to a customer. After presenting the offer to the customer, the call center agent selects an appropriate disposition code and clicks “OK.” The disposition code is returned to the database where the offer status is updated.

### BRIEF DESCRIPTION OF THE DRAWINGS

FIG. 1 is a block schematic diagram of an architecture for a sales and service offer method and apparatus according to the invention;

FIG. 2 is a flow diagram showing a sales and service offer method according to the invention;

FIG. 3 is a flow diagram showing a process float through a database server according to the invention;

FIG. 4 is a screen showing authentication at an agent desktop according to the invention;

FIG. 5 is a screen shot showing a sales agent screen according to the invention;

FIG. 6 is a screen shot showing a sales and marketing offer according to the invention;

FIG. 7 is a service impact offer screen according to the invention; and

FIG. 8 is a screen shot showing that an offer had already been presented according to the invention.

### DETAILED DESCRIPTION OF THE INVENTION

The invention provides a low cost and flexible system for presenting targeted sales offers and/or customer service to customers, where call center agents are alerted to such offers via a call center desktop application during a service related customer call. The preferred embodiment of the invention leverages existing interactive voice response (IVR), CTI, and customer information view (CIV) infrastructure, and extends current CTI capabilities.

More particularly, a mechanism is provided that identifies a customer and attaches a relevant sales or service offer code to a customer inquiry. When a sales/service agent is in contact with the customer, the sales/service agent's display illuminates a sales/service offer icon as appropriate. When the sales/service agent clicks on the icon, the system calls an associated URL and launches a browser, which then displays a description of the offer and a suggestion script. After presenting the offer to the customer, the sales/service agent selects an appropriate disposition code, which is recorded in a database with regard to offer status. One unique feature of the invention concerns passing a URL associated with an offer along with a phone call to an agent in a call center.

One goal of the invention is to provide a system that allows a company to present customer and/or account specific information or scripts to call center agents via their desktop within hours if not minutes after learning of a critical service failure impacting the company's customers. The invention solves the lead-time, change risk, customer impact and cost issues associated with other methods of dynamic offer presentation by taking advantage of Hyper Text Markup Language (HTML) and Active Server Page (ASP) technologies developed for the Internet. A URL and OfferID are attached to the voice call as CTI data. When the desktop receives the CTI data, the OfferID acts as a trigger causing the offer icon to flash. When the user clicks on the offer icon, the desktop opens a browser and calls the URL previously passed as CTI data. The sales script and a set of disposition codes are then displayed in the ASP.

Using this approach it is possible to modify the sales script and disposition codes in a matter of minutes, making it possible to test various scripts for effectiveness. Thus, sales campaigns can be put into production within hours of the time the request was made. This is all done without impacting the code on the IVR or desktop.

In a current embodiment, the IVR is used to attach pieces of data to an agent initiated database query, where such pieces of data are gathered either directly by customer entered digits (CED's) or following a database lookup based upon CED's. The data are organized in a one-to-one relationship, known as key value pairs. For example, for the data element account number, the key is AcctNum and the value is 0836553285. The key value pairs are passed to the CIV desktop application in a string via IVR software, such as that provided by Genesys Laboratories (Daly City, Calif.) and Cisco Systems (San Jose, Calif.).

The CTI software calls a stored procedure using the account number and SSN that were attached as key value pairs by the IVR. The stored procedure performs a database lookup using the account number and social security number (SSN) as input arguments. When matching on an SSN, a sales offer code and sales offer URL are attached as key value pairs. As a result of a match on account number, a service offer code and service offer URL are attached as key value pairs. In either case, the additional key value pairs are appended to the string and passed to the desktop.

The desktop interrogates the string of key value pairs. When an offer code and URL are present, the desktop illuminates a sales offer icon and/or a service offer icon on the call center agent's desktop as appropriate. Once the call center agent clicks on an icon, the desktop calls the URL passed in the string and launches a browser. An ASP file is pushed to the desktop and an HTML page within the browser displays a description of the offer and a suggested script for the sales agent to follow when presenting the offer to a customer. After presenting the offer to the customer, the call center agent selects an appropriate disposition code and clicks “OK.” The disposition code is returned to the database where the offer status is updated.

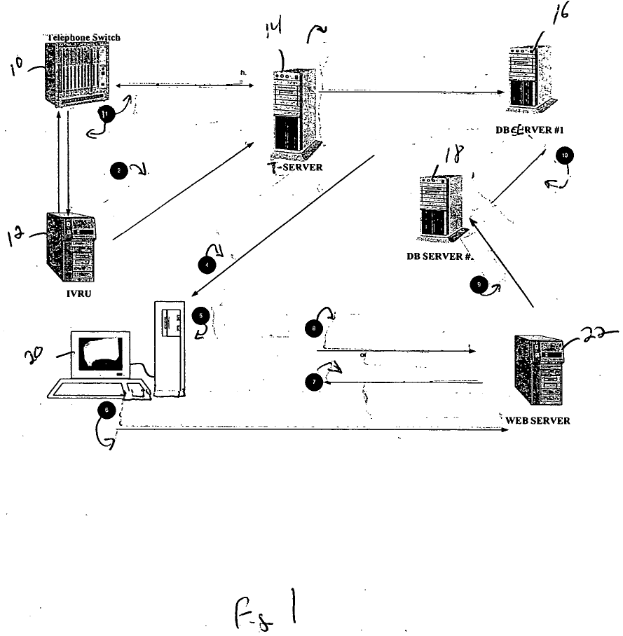

FIG. 1 is a block schematic diagram showing an architecture that supports a sales and service offer method and apparatus according to the invention. The preferred embodiment of the invention consists of a telephone switch 10, an Interactive Voice Response Unit (IVRU) 12, a Telephone Services Server 14, Database Servers 16, 18, an Agent Desktop 20, and a Web Server 22.

In operation, the telephone server monitors call events on the telephone switch, and an intelligent router strategy (IR) is loaded onto a control data node (CDN). Further, the telephone switch transfers an incoming call to the IVRU. These actions are indicated on FIG. 1 by the numeric designator (1). If the customer requests the assistance of an agent (or banker), the IVRU attaches key value pairs (KV) and transfers the call back to the telecommunication server (2). The IR performs a database search (3). The routing strategy calls a stored procedure, inquiring about program offers for the key value pairs CompanyID+ and Account Number or SSN. If an offer exists in the database for the CompanyID+ Account or SSN, the OfferID and the URL are returned to the routing engine. The routing software attaches the OfferID and URL as additional KV pairs to the current call. Thereafter, the telephone telecommunication server passes the KV pairs to the agent desktop (4). The agent desktop highlights CTI, marketing, and service icons as appropriate (5). The agent desktop then makes a request from the Web server after the agent clicks on an appropriate highlighted icon (6). The agent desktop passes the customer's object ID, SSN, Account Number, COID, the agent's phone number and desktop ID, sales offer ID and URL or service offer ID and URL, and the first three octets of the desktop IP to the Web server. The Web server thereafter responds to the agent desktop by sending a Web form (7). The agent desktop displays the Web form. When the agent closes the browser, the agent desktop makes a request to the Web server to update the database with an offer disposition, privacy, and opt out data as appropriate (8). The Web server then updates an SQL database with offer disposition and agent referral data (9). The database server, which contains disposition and agent referral data, updates a sales and service database server by deleting offers that were previously dispositioned in the agent's desktop. This is typically part of an end of day process (10).

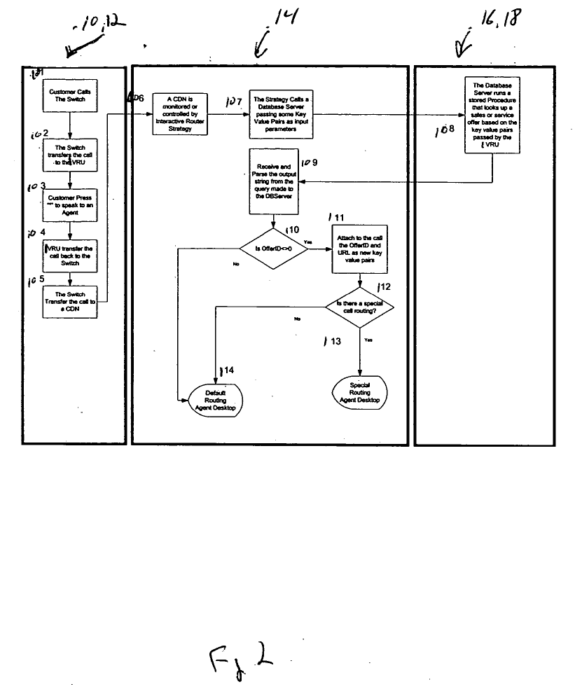

FIG. 2 is a flow diagram showing a sales and service offer method according to the invention. The process is shown in FIG. 2 in connection with the elements identified on FIG. 1 as a telephone switch and an IVRU 12, the telephone communication server 14 (CTI and interactive router), and the database servers 16, 18. At the beginning of the process, a customer places a call to an institution, such as a bank (101). The call is received by a switch, which transfers the call to the IVRU (102). A pre-recorded message on the IVRU instructs the customer to press a button on the telephone keypad, such as an “*,” to speak to an agent (103). The IVRU then transfers the call back to the telephone switch (104), and the switch transfers the call to the appropriate control data node (105). A control data node is monitored or controlled by the interactive router strategy (IR) (106). The routing strategy calls a database server and passes key value pairs thereto as input values (107). The database servers run a stored procedure that looks up a sales or service offer based on the key value pairs that are passed to it by the CTI application (108). The telephone server then receives these key value pairs and parses the output string from the query made by the database server (109). A determination is made if there is an OfferID (110). If there is no OfferID, then there is a default routing of the message to the agent's desktop (114). If there is an OfferID, then the the OfferID and the URL are attached to the call as new key value pairs (111), and a determination is made whether there a special call routing is required or not (112). If there is no special call routing required, then a default routing is made of the call to the agent desktop (114). Otherwise, there is a special routing to the agent's desktop (113).

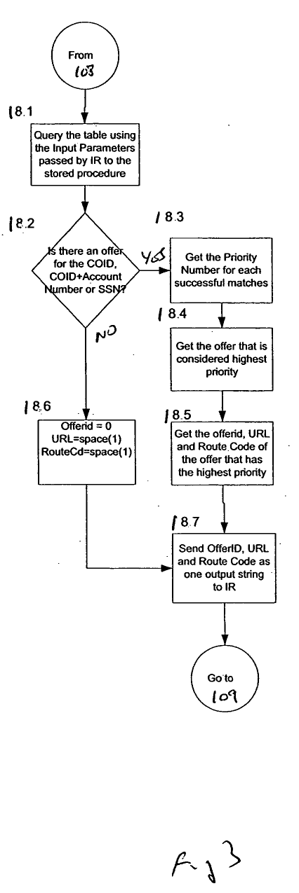

FIG. 3 is a flow diagram showing the database operations of FIG. 2 in greater detail according to the invention. In FIG. 3, the process begins when a strategy (IR) calls a database server, passing key value pairs thereto as input parameters. The database queries a table using the input parameters passed by the IR to the stored procedure (181). A determination made if there is an offer for the COID, a COID+Account Number or SSN (182). If not, e.g. OfferID=0, a URL is=space(1), and a RouteCd=space(1) (186). The OfferID, URL, and Route Code are sent to the IR as one output string (187) and the process continues as set forth in FIG. 2 (109). If there is an offer, then a priority number is obtained for each of the successful matches (183). The offer for the highest priority is obtained (184), and the OfferID, URL, and Route Code for the offer is obtained (185). The OfferID, URL, and Route Code are then output as a string to the routing strategy (187), and the process continues as set forth on FIG. 2 (109).

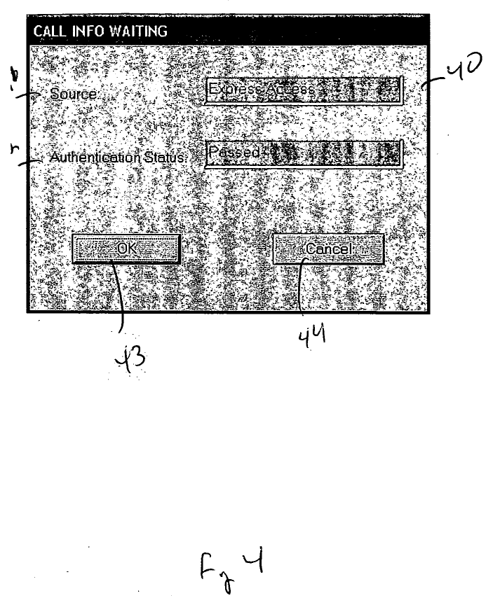

FIG. 4 is a screen shot of a first screen that appears when a call is routed to the IVRU. On the screen 40, a source is indicated 41 and an authentication status is indicated 42. This means that the caller was correctly authenticated to the agent. The agent may then accept the call by clicking the OK button 43, or he may cancel the call by clicking the cancel button 44.

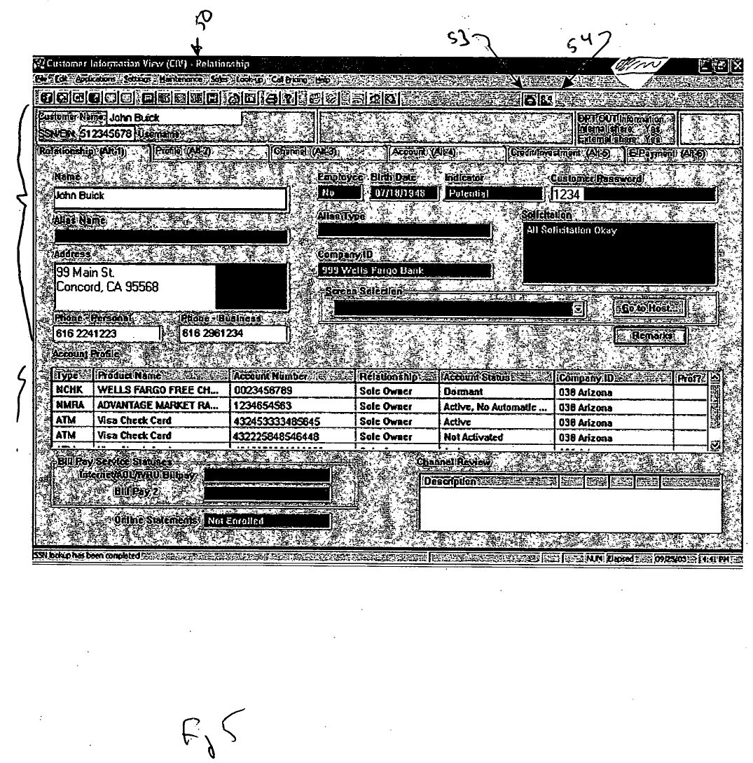

FIG. 5 is a screen shot showing the information that is provided to the agent on the agent desktop once a call is accepted. On the screen 50, various fields are provided which contain the customer name and other information relating to the customer 51. Fields are also provided which identify the customer's current product information 52. The example shown in FIG. 5 is that of a bank in which the products are financial products. However, it should be appreciated by those skilled in the art that the invention is applicable to any organization in which a telephone service facility is provided. Thus, the invention may be used by any customer support center to identify sales opportunities in response to customer calls.

In the example of FIG. 5, indicators are provided when sales opportunities are found by the system to be appropriately linked to the customer call. Thus, an icon 53 is shown in the menu bar. When there is a sales or marketing offer available, the agent is alerted to such offer by some sort of illumination or blinking of the icon. In this way, the agent's attention is drawn to the sales opportunity. It should be appreciated by those skilled in the art that while an icon is shown in FIG. 5, any other form of attention getting mechanism may be used to draw the agent's attention to the sales opportunity. An additional icon 54 is shown which is referred to in this embodiment of the invention as a service impact icon. This icon is blinking when the customer can be provided with a service impact offer. Thus, a distinction may be made between the types of offers available to the customer; or multiple offers may be indicated by the provision of multiple icons.

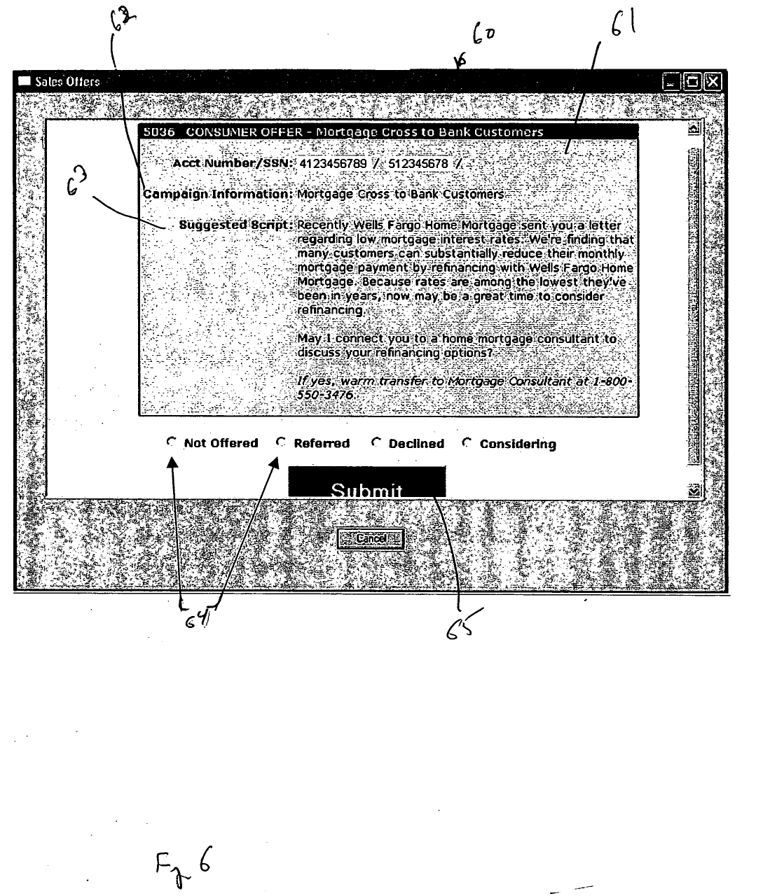

FIG. 6 is a screen shot which shows a script for a sales and marketing offer. On the screen 60, a script is provided 61, which includes both sales campaign information 62 and the actual suggested script 63. Various disposition buttons 64 are provided that show the disposition of the offer. Thus, the agent may decide that it is not appropriate to offer the opportunity to the customer, may refer the opportunity to the customer, may refer the opportunity to a sales agent if the customer indicates that they are interested in pursuing the offer, or may indicate that the offer was declined or that the customer is considering the offer. Once a disposition is made, the agent may hit a submit button 65 and the disposition code is then captured by the system.

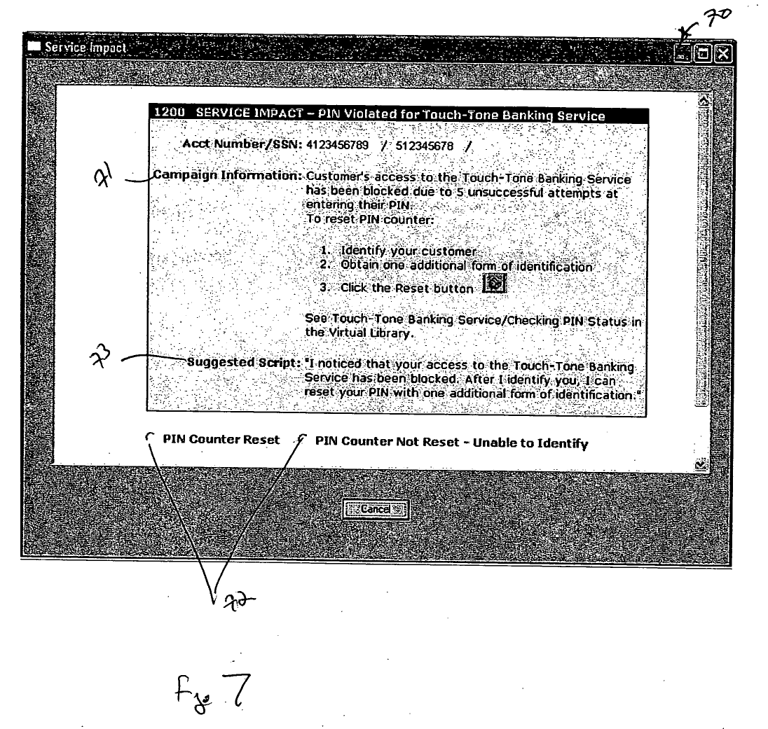

FIG. 7 is a screen shot showing a service impact offer screen 70. The screen shows the service impact information 71, as well as customer information. The service impact dispositions are displayed as well 72. On the screen, the agent chooses the appropriate disposition and hits a submit button. In the example of FIG. 7 the submit button is not shown, but is available when the screen is scrolled in the agent's desktop. In the example of FIG. 7, a script 73 is provided that shows that the service impact deals with a PIN violation for touch tone banking service. Those skilled in the art will appreciate that service impacts may be of other types as well, and that the invention is not limited to just the example of the financial services industry.

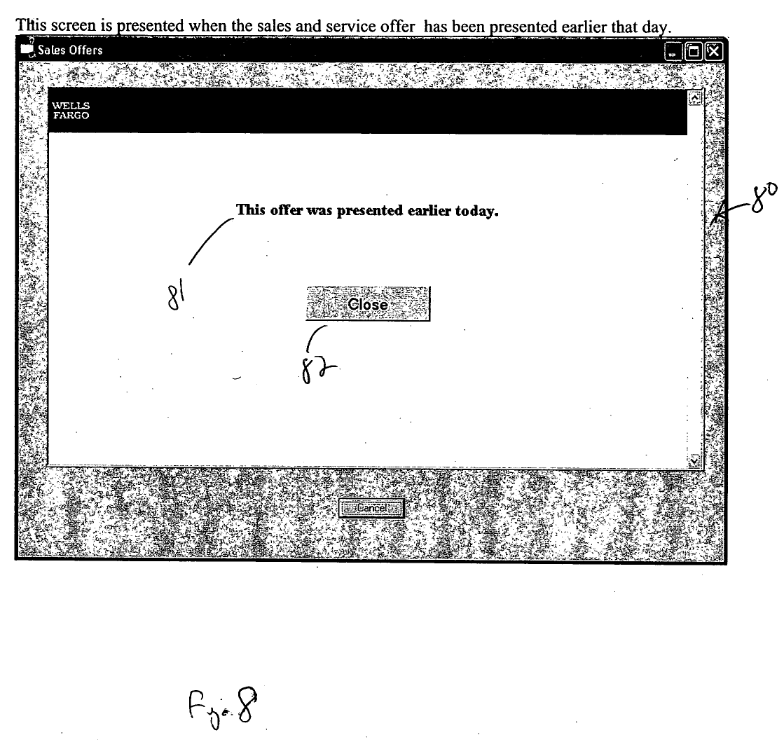

FIG. 8 is a screen that is displayed to an agent when an offer has already been presented earlier in the day. On the screen 80, a message is provided that states that the offer was presented earlier 81. Once the agent has received the information, he can click on a close button 82 and proceed with attending to other customer calls, or complete the call he is currently servicing. Those skilled in the art will appreciate that the daily period for indicating that an offer had been presented is a matter of choice in that the agent may be notified with regard to the offers that are presented on a weekly basis, monthly basis, hourly basis, etc. as appropriate. Further, the agent may be presented with information in addition to the disposition indicated in FIG. 8. Thus, rather than merely indicating the offer was presented earlier in the day, annotations may be included which provide additional information to the agent, or further sales offers may be provided that may be made to the customer.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A sales and service offer apparatus, comprising:
means for identifying a customer and attaching to a customer inquiry a relevant sales or service offer code;
means for illuminating a sales/service offer icon on a sales/service agent's display in a call center when said sales/service agent is in contact with said customer;
means for calling an associated URL and launching a browser which then displays a description of said sales/service offer and a suggestion script when said sales/service agent clicks on said sales/service offer icon; and
means for said sales/service agent selecting an appropriate disposition code, which is recorded in a database with regard to said sales/service offer status after presenting, said sales/service offer to said customer.

2. The apparatus of claim 1, said means for identifying a customer and attaching to a customer inquiry a relevant sales or service offer code further comprising:
means for passing a URL associated with an offer along with a phone call to an sales/service agent.

3. A sales and service offer method, comprising the steps of:
identifying a customer during a customer phone call; and
passing a URL linked to a sales/service offer, along with said customer phone call, to a sales/service agent in a call center.

4. The method of claim 3, further comprising the step of:
illuminating a sales/service offer icon on a sales/service agent's display in said call center when said sales/service agent is in contact with said customer.

5. The method of claim 4, further comprising the step of:
calling said URL and launching a browser which then displays a description of said sales/service offer and a suggestion script when said sales/service agent clicks on said sales/service offer icon.

6. The method of claim 5, further comprising the step of:
said sales/service agent selecting an appropriate disposition code, which is recorded in a database with regard to said sales/service offer status after presenting, said sales/service offer to said customer.

7. An apparatus for presenting targeted sales offers and/or customer service to customers, comprising:
means for identifying a customer during a service related customer phone call;
means for passing a URL linked to said sales offers and/or customer service, along with said customer phone call, to a sales/service agent in a call center and
means for alerting said call center agent to said sales offers and/or customer service via a call center desktop application during said customer call.

8. A customer service method, comprising the steps of:
attaching a URL and OfferID to a customer voice call as computer telephony integration (CTI) data;
when a call center agent desktop receives said CTI data, said OfferID acting as a trigger causing an offer icon on said desktop to illuminate;
when said call center agent clicks on said offer icon, said desktop opening a browser and calling said URL which was previously passed as CTI data; and
displaying a sales script and a set of disposition codes on said desktop.

9. The method of claim 8, wherein customer and/or account specific information or scripts are presented to said call center agent via said desktop after learning of a critical service failure impacting a customer.

10. The method of claim 8, further comprising the step of:
attaching pieces of data to an agent initiated database query, where such pieces of data are gathered either directly by customer entered digits (CED's) or following a database lookup based upon CED's.

11. The method of claim 10, wherein said data are organized as key value pairs.

12. The method of claim 10, further comprising the step of:
calling a stored procedure using a customer account number and SSN, wherein said stored procedure performs a database lookup using said account number and SSN as input arguments.

13. The method of claim 12, further comprising the step of:
when matching on an SSN, attaching a sales offer code and sales offer URL to a response as key value pairs.

14. The method of claim 12, further comprising the step of:
when matching on an account number, attaching a service offer code and service offer URL to a response as key value pairs.

15. The method of claim 12, further comprising the steps of:
interrogating a string of key value pairs; and
when an offer code and URL are present, illuminating said offer icon and/or a service offer icon.

16. The method of claim 15, further comprising the steps of:
once said call center agent clicks on an icon, calling said URL and launching a browser; and
displaying a page within said browser containing a description of said offer and a suggested script for said sales agent to follow when presenting said offer to a customer.

17. The method of claim 16, further comprising the steps of:
after presenting said offer to said customer, said call center agent selecting an appropriate disposition code; and
returning said disposition code is returned to a database where offer status is updated.
